(19) United States
(12) Patent Application Publication
(10) Pub. No.: US 2023/0173583 A1
(43) Pub. Date: Jun. 8, 2023

(54) ANCHOR STRUCTURES

(71) Applicant: Hewlett-Packard Development Company, L.P., Spring, TX (US)

(72) Inventors: Ismael Fernandez Aymerich, Sant Cugat del Valles (ES); Roger Fadurdo Orellana, Sant Cugat del Valles (ES); Cristina Dominguez Manchado, Sant Cugat del Valles (ES)

(73) Assignee: Hewlett-Packard Development Company, L.P., Spring, TX (US)

(21) Appl. No.: 17/921,115

(22) PCT Filed: Jun. 25, 2020
(86) PCT No.: PCT/US2020/039664

§ 371 Date: Oct. 25, 2022

(51) Int. Cl. B22F 10/85; B33Y 50/02; B29C 64/393

(52) U.S. Cl. CPC B22F 10/85; B33Y 50/02; B29C 64/393

(57) ABSTRACT

A computing device comprising a controller is disclosed herein. The controller is to receive an arrangement of a 3D object a virtual build volume to be generated by a 3D printer; determine an indication of the expected warpage of a portion of the 3D object; and modify the virtual build volume to add at least one anchor structure connected to the portion of the 3D object if the expected warpage is above a predeterminable threshold.

### BACKGROUND

Some additive manufacturing or three-dimensional printing systems generate 3D objects by selectively solidifying portions of a successively formed layers of build material on a layer-by-layer basis. The build material which has not been solidified is separated from the 3D objects to conclude the additive manufacturing process.

### BRIEF DESCRIPTION OF THE DRAWINGS

The present application may be more fully appreciated in connection with the following detailed description of non-limiting examples taken in conjunction with the accompanying drawings, in which like reference characters refer to like parts throughout and in which:

FIG. 1 is a schematic diagram showing an example of a computing system to modify a virtual build volume to add at least one anchor structure;

FIG. 2 is a flowchart of an example method of modifying a virtual build volume to add at least one anchor structure;

FIG. 3A is a schematic diagram showing an example of an anchor structure;

FIG. 3B is a schematic diagram showing an example of a virtual build volume with a set of anchor structures;

FIG. 4 is a flowchart of an example method of arranging a 3D object in a virtual build volume;

FIG. 5 is a flowchart of another example method of arranging a 3D object in a virtual build volume; and

FIG. 6 is a block diagram showing a processor-based system example of a system to modify a virtual build volume to add at least one anchor structure.

### DETAILED DESCRIPTION

The following description is directed to various examples of additive manufacturing, or three-dimensional printing, apparatus and processes involved in the generation of 3D objects. Throughout the present disclosure, the terms “a” and “an” are intended to denote at least one of a particular element. In addition, as used herein, the term “includes” means includes but not limited to, the term “including” means including but not limited to. The term “based on” means based at least in part on.

For simplicity, it is to be understood that in the present disclosure, elements with the same reference numerals in different figures may be structurally the same and may perform the same functionality.

3D printers generate 3D objects based on data in a 3D model of an object or objects to be generated, for example, using a CAD computer program product. This data may be pre-processed by a computing system in a suitable format for the 3D printer. In some examples, the pre-processing may include virtually arranging the 3D objects to be generated in a virtual build volume corresponding to the physical build volume in which the 3D objects are to be generated, for example in a 3D printer. A print job describing the arrangement of 3D objects within the virtual build volume may be sent to the 3D printer to cause the printer to generate the 3D objects.

3D printers may generate 3D objects by selectively processing layers of build material. For example, a 3D printer may selectively treat portions of a layer of build material, e.g. a powder, corresponding to a slice of 3D object to be generated, thereby leaving the portions of the layer un-treated in the areas where no 3D object is to be generated. The combination of the generated 3D objects and the un-treated build material may also be referred to as build volume. The volume in which the build volume is generated may be referred to as a build chamber.

Suitable powder-based build materials for use in additive manufacturing include polymer powder, metal powder or ceramic powder. In some examples, non-powdered build materials may be used such as gels, pastes, and slurries.

Some 3D printers may selectively treat portions of a layer of build material by ejecting a printing fluid in a pattern corresponding to the 3D object and then apply energy to the layer. 3D printers may apply energy to the build material layer, using for example, an energy source. Examples of printing fluids may include fusing agents, detailing agents, curable binder agents or any printing fluid suitable for the generation of a 3D object. After the 3D printing operation corresponding to the generation of the 3D objects within a plurality of build material layers, the build volume may cool down so that the 3D objects may be separated from the un-solidified build material.

The 3D objects may suffer a distortion of the surface compared to the intended shape of the design, for example de CAD file, therefore leading to dimensional accuracy defects of the generated 3D objects. This distortion is referred hereinafter as warping and may be influenced, for example, by the cooling of the build volume after the printing and subsequent heating operations. Nonuniformity of the cooling of different parts of a 3D object may cause internal residual tensions within the 3D object which cause warping. Nonuniform cooling, and thereby warping, may be influenced by the geometry of the 3D object. Therefore, some geometries may be more resistant to warp than other geometries. In some examples, a 3D object to be generated may comprise different portions with different geometries that may warp in different ways. Furthermore, the contents of a build chamber may not cool down uniformly, therefore a 3D object generated in an inner sub-volume of the build chamber may tend to warp differently than if the 3D object was generated in another inner sub-volume of the build chamber.

Therefore, some examples of computing systems that pre-process virtual build volumes may take into consideration the geometry of the 3D objects to be generated and the location within the build chamber where the 3D objects are to be generated when defining the virtual build volume data to be sent to the 3D printer. However, due to the volume limitations of the build chamber, there may be some 3D objects that are placed in a sub-volume, cooling of which may cause warping of the 3D object, because there is no more available room in the warping-free sub-volumes. This may occur, for example, in virtual build volumes which are packed of geometrically similar printed parts.

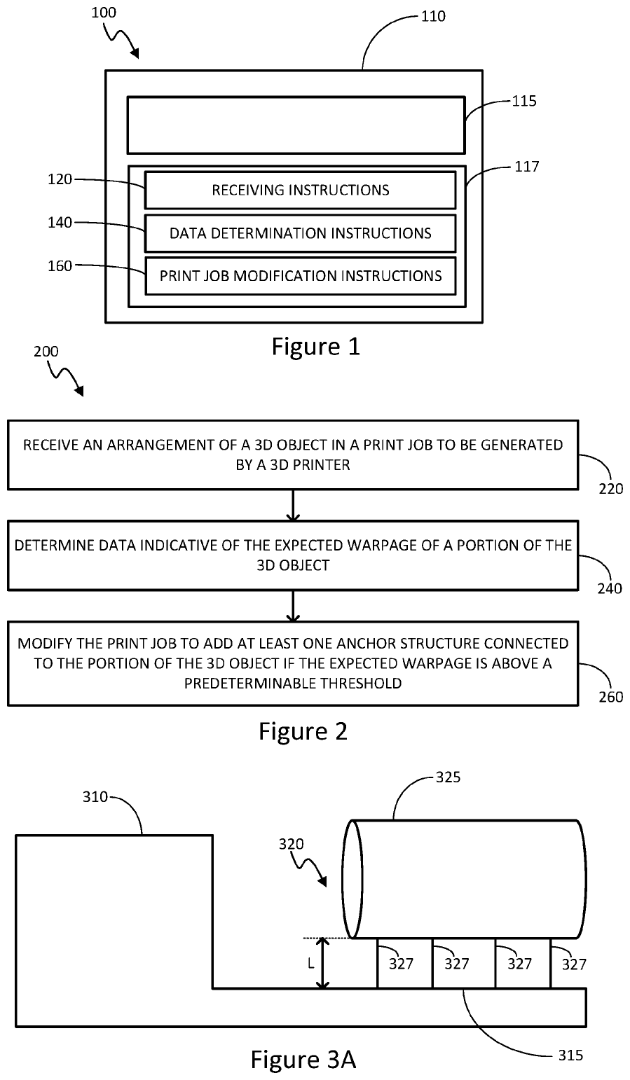

Referring now to the drawings, FIG. 1 is a schematic diagram showing an example of a computing system 100. The computing system 100 may be an integral part of a 3D printer or an external system from the 3D printer that may interact with the 3D printer, for example an external computing unit suitable for sending data to the 3D printer.

The computing system 100 comprises a controller 110. The controller 110 comprises a processor 115 and a memory 117 with specific control instructions 120-160 to be executed by the processor 115. The functionality of the controller 110 is described further below with reference to FIG. 2.

In the examples herein, the controller 110 may be any combination of hardware and programming that may be implemented in a number of different ways. For example, the programming of modules may be processor-executable instructions stored in at least one non-transitory machine-readable storage medium and the hardware for modules may include at least one processor to execute those instructions. In some examples described herein, multiple modules may be collectively implemented by a combination of hardware and programming. In other examples, the functionalities of the controller 110 may be, at least partially, implemented in the form of an electronic circuitry. The controller 110 may be a distributed controller, a plurality of controllers, and the like.

FIG. 2 is a flowchart of an example method 200 of modifying a virtual build volume to add at least one anchor structure. In some examples, blocks 220-260 from method 200 may correspond to the instructions 120-160 from FIG. 1 respectively, instructions of which when executed, cause the processor 115 of the controller 110 to perform the method 200 of FIG. 2.

At block 220, the controller 110 receives an arrangement of a 3D object in a virtual build volume to be generated by a 3D printer. The arrangement comprises the position and orientation of the 3D object within the virtual build volume. In some examples, the controller 110 may receive an arrangement with a plurality of 3D objects in the virtual build volume. In even further examples, the controller 110 may receive data corresponding to a plurality of 3D objects to be generated and may arrange the plurality of 3D objects in a virtual build volume.

Different parts of a generated 3D object may warp in different ways upon cooling based on the geometry of the different parts or the location from the build volume in which the parts are arranged. At block 240, the controller 110 determines data indicative of the expected warpage of a portion of the 3D object. In an example, the data may include geometrical ratio computations of the part of the 3D object indicative of the warpage of the part. Additionally, or alternatively, the controller 110 may further compare the location in which the part is arranged with a mathematical model indicative of the expected cooling of each position within the build volume in order to determine the data indicative of the expected warpage of the portion of the 3D object.

In some examples, the controller 110 may compare the data indicative of the expected warpage with a set of predetermined or predeterminable thresholds. In some examples, the thresholds may be based on a specified end use of the 3D objects, quality requirements, mechanical properties requirements or dimensional accuracy of the generated 3D objects.

At block 260, the controller 110 modifies the virtual build volume to add at least one anchor structure connected to the portion of the 3D object if the expected warpage is above the threshold. An anchor structure is an object generated by the 3D printer with a warpage resistant geometry that may minimally deform compared to the portion of the 3D object that the anchor structure is connected thereto. The anchor structure is connected to the portion of the 3D object which is expected to warp to prevent, or at least reduce, warping of that object portion. For example, the anchor structure may cause a force on the portion of the 3D object to counteract the internal tensions that generate the warpage of the object portion and, therefore, mitigate the warpage effect of the portion of the 3D object.

Additionally, the controller 110 may send the modified virtual build volume to, for example, a controlling unit of a 3D printer. However, in some examples, the controller 110 may slice the resulting modified virtual build volume and send the plurality, or a subset of the plurality, of slices corresponding to the modified virtual build volume to the 3D printer.

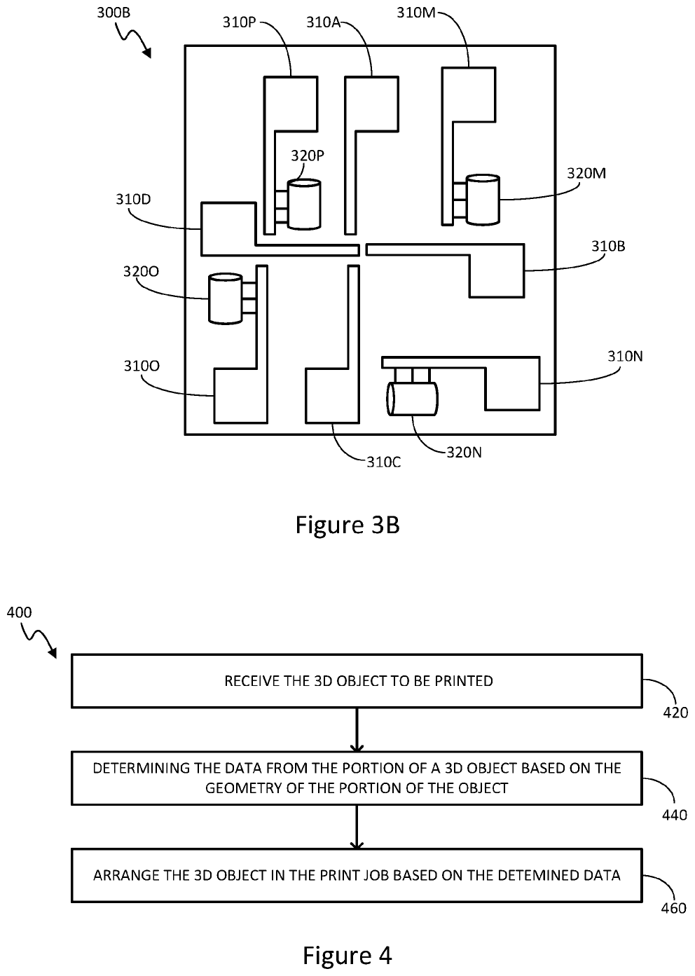

FIG. 3A is a schematic diagram showing an example of an anchor structure 320 connected to a portion 315 of a 3D object 310 which is expected to warp upon cooling.

The anchor structure 320 comprises a body 325 located at an offset (illustrated as distance L) from the 3D object 310. In some examples the distance L may be selected from the range defined from 0.5 cm to 5 cm. In other examples, the distance L may be larger than 5 cm. In some examples, the body 325 may be a solid element. A solid element may be understood as a body integrally comprised by fused or solidified build material (i.e., without enclosing un-solidified build material therein). In other examples, the body 325 may comprise a solid shell enclosing un-solidified build material. The body 325 has a deformation stable shape so that the body 325 may not warp even in warpage adverse conditions. In an example, at least part of the body 325 may comprise a cubical shape, a spherical shape, a rectangular section prism shape, and/or a cylindrical shape.

The anchor structure 320 further comprises at least one pin 327 to connect the body 325 with the portion 315 of the 3D object 310. Pins 327 are to transfer a force from the body 325 to the portion 315 of the 3D object 310 to counteract, and thereby mitigate, the internal tensions of the portion 315 that cause warpage. The pin 327 offsets the body 325 and the portion 315 of the 3D object 310 so that the heat emitted by the body 325 during object generation has a negligible effect in the cooling rate of the portion 315 of the 3D object 310. In an example, the anchor structure 320 comprises a plurality of pins 327 connected to the body 327 that extend along the surface of the portion 315.

The pins 327 may be relatively thin compared to the size of the body 325 and the 3D object 310. In an example, the pin 327 may have a diameter of 2 mm or less. In another example, the pin 327 may have a diameter of 1 mm or less. Furthermore, in some examples, the pin 327 is thin so that upon cooling down of the 3D object, the anchor structure 320 can be easily separated from the 3D object by breaking or cutting the pin 327, for example at the contact surface of the portion 315 with the pin 327.

In an example, the anchor structure 320 comprises a plurality of pins 327 of the same length. In another example, the anchor structure 320 comprises at least two pins 327 of different lengths, for example, to adapt to a curved shape of the portion 315. In yet other examples, a plurality of anchor structures 320, each anchor structure with a plurality of pins 327 of substantially the same length, may be used to adapt to a curved shape of the portion 315.

Additionally, in some examples, the anchor structure 320 may further comprise a reinforcement portion (not shown) between the body 310 and a pin 327. The reinforcement structure may aid the pin 327 not to deform during cooling and, therefore, provide resistance to breakage during cooling caused by the internal tensions of the portion 315 of the 3D object 310. In an example, the reinforcement structure may be a set of reinforcement pins generated between a portion of the body 325 and a portion of the pin 327. In other examples, the reinforcement structure may comprise another shape such as a cone, a pyramid or any other shape suitable for providing additional resistance to breakage during cooling of the pin 327.

FIG. 3B is a schematic diagram showing an example of a vertical or a horizontal virtual cross-section of a modified virtual build volume 300B with a set of anchor structures 320M-P. In an example, the virtual build volume 300B may be the modified virtual build volume resulting from the execution of block 260 from FIG. 2. The virtual build volume 300B may comprise previously disclosed elements from FIGS. 1 and 3A referred to with the same reference numerals.

As mentioned above, the contents of build chambers tend to cool down unevenly and this may cause warpage of the 3D objects generated therein. Warpage may be accentuated based on the geometry of the 3D objects. Some portions of a 3D object tend to warp more than others, therefore the similar portions of similar objects allocated in different parts of the build chamber may warp differently.

In the example herein, the virtual build volume 300B includes eight 3D objects 310A-D and 310M-P. For simplicity, the 3D objects are illustrated as comprising a similar geometry with a first wider portion which is resistant to warping and a second thinner portion which tends to warp more easily. However, it is to be understood that 3D objects with different geometries may have been illustrated instead without departing from the scope of the present disclosure.

Cubical, cylindrical and prismatic shaped build chambers tend to cool down more evenly in the build chamber than at the locations in proximity to the outer walls of the build chamber. Therefore, in some examples, the virtual build volume received at block 220 may comprise an arrangement of the 3D objects 310A-D and 310M-P in which the first wider portions of the 3D objects may be positioned towards the outer walls locations of the internal volume of the build chamber and that the second thinner portions of the 3D objects may be positioned towards the core portion of the internal volume to minimize the overall warpage rate of the full 3D objects. In some examples, the arrangement of the 3D objects may be executed elsewhere and then sent to the controller 100 (block 220). In other examples, however, the controller may re-arrange the received arrangement prior to the execution of block 240.

However, the thinner portions of some 3D objects (i.e., the thinner portions of 3D objects 310M-P) positioned further away from the core portion of the internal volume of the build chamber may therefore be subject to a more severe warping than the thinner portions of the 3D objects 310A-D that were positioned closer to the core portion of the internal volume.

In the example, the controller 110 may determine whether the data indicative that the expected warpage of the second thinner portions of 3D objects 310M-P exceeds the predeterminable threshold and may, in response thereto, generate an anchor structure 320M-P connected to each of the second thinner portions of the 3D objects 310M-P respectively to mitigate the warping (e.g., blocks 240 and 260 of FIG. 2). The anchor structure 320M-P may be similar to the anchor structure 320 of FIG. 3A.

Additionally, in further examples, a single anchor structure body may comprise a first set of pins to connect to a portion of a first 3D object and a second set of pins to connect to a portion of a second 3D object to reduce the printed anchor structure footprint within the build chamber.

FIG. 4 is a flowchart of an example method 400 of arranging a 3D object in a virtual build volume. The method 400 may involve previously disclosed elements from FIGS. 1, 2, 3A-B referred to with the same reference numerals. In some examples, method 400 may be executed by the controller 110 of FIG. 1. In some examples, method 400 may be executed instead of block 220 of method 200 from FIG. 2.

At block 420, the controller 110 may receive a 3D object to be generated or an arrangement of a set of 3D objects in a virtual build volume (e.g., block 220 of FIG. 2). In some examples, the 3D object may have a plurality of portions with different geometries.

At block 440, the controller 110 may determine data from a portion of the 3D object based on the geometry of the portion. These data may be indicative of the expected warpage of the 3D object after its generation and cooling. In an example, data indicative of a high expected warpage may include that the portion of the 3D object comprises a high surface (e.g., product of two dimensions of the portion) and a low volume (e.g., product of three dimensions of the portion), for example, a large and thin plate-like portion of a 3D object. In another example, data indicative of a high expected warpage may include that a warpage-expected-portion of the 3D object is connected to another portion of the 3D object, which is large, solid and/or high dense compared to the warpage-expected-portion. In another example, data indicative of a low expected warpage may include that the portion of the 3D object comprises a deformation stable shape, such as a cubical shape, a spherical shape, a rectangular-section prismatic shape, and/or a cylindrical shape.

At block 460, the controller 110 may arrange the 3D object in the virtual build volume based on the determined data. Alternatively, if the controller 110 received an arrangement of a set of 3D objects in a virtual build volume (block 420), at block 460, the controller 110 may re-arrange the 3D objects within the virtual build volume based on the determined data. In an example, if the determined data is indicative that the portion of the 3D object is expected to suffer a high warpage, the controller 110 may arrange the portion of the 3D object in a virtual build volume location corresponding to a stable cooling position of the build chamber, for example, a location in proximity to the central position (i.e., core position) of the build chamber. If, otherwise, the determined data is indicative that the portion of the 3D object is expected to suffer a low warpage, or is not expected to suffer warpage, the controller 110 may, in some examples, arrange the portion of the 3D object in a virtual build volume location corresponding to a less-stable cooling portion of the build chamber, to free the stable cooling positions of the build chamber for other portions of the 3D object (or additional 3D objects) that are expected to suffer a more severe warpage.

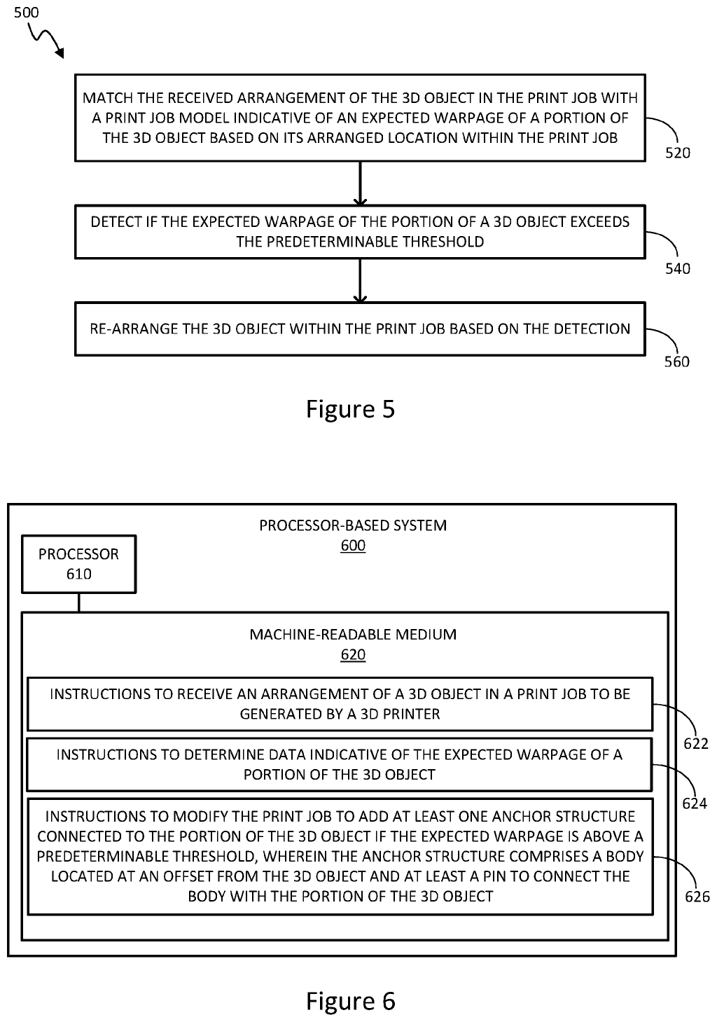

FIG. 5 is a flowchart of another example method 500 of arranging a 3D object in a virtual build volume. The method 500 may involve previously disclosed elements from FIGS. 1, 2, 3A-B referred to with the same reference numerals. In some examples, method 500 may be executed by the controller 110 of FIG. 1. In some examples, method 500 may be executed between blocks 220 and 240 of method 200 from FIG. 2. In other examples, method 500 may be executed after method 400 from FIG. 4.

At block 520, the controller 110 may compare the received arrangement of the 3D object in the virtual build volume with a virtual build volume model. A virtual build volume model is a mathematical computer model indicative of an expected warpage of a portion of the 3D object based on its arranged location within the virtual build volume. In an example, the virtual build volume model is a thermal model that indicates the cooling characteristics of each location of the build chamber which is indicative of the warpage rate. In another example, the virtual build volume model is a shrinkage model that indicates the shrinkage rate of each location of the build chamber.

At block 540, the controller 110 may, upon comparing the received arrangement of the 3D object with the virtual build volume model, detect if the expected warpage of the portion of the 3D object exceeds the predeterminable threshold indicative of an excessive expected warpage.

At block 560, the controller 110 may re-arrange the 3D object within the virtual build volume based on the detection of the expected warpage of the portion of the 3D object. In an example, if the detected expected warpage of the 3D object at its current position is relatively high, the controller 110 may re-arrange the portion of the 3D object in a virtual build volume location corresponding to a more stable cooling position of the build chamber, for example, a location in proximity to the central position of the build chamber. If, otherwise, the detected expected warpage of the 3D object is low or nil, the controller 110 may re-arrange the portion of the 3D object in a virtual build volume location corresponding to a less-stable cooling portion of the build chamber, to free the stable cooling positions of the build chamber for other portions of the 3D object (or additional 3D objects) that are expected to suffer a more severe warpage.

FIG. 6 is a block diagram showing a processor-based system 600 example of a system to modify a virtual build volume to add at least one anchor structure. In some implementations, the system 600 may be or may form part of a computing system and/or a 3D printing system, such as a 3D printer. In some implementations, the system 600 is a processor-based system and may include a processor 610 coupled to a machine-readable medium 620. The processor 610 may include a single-core processor, a multi-core processor, an application-specific integrated circuit (ASIC), a field programmable gate array (FPGA), and/or any other hardware device suitable for retrieval and/or execution of instructions from the machine-readable medium 620 (e.g., instructions 622-626) to perform functions related to various examples. Additionally, or alternatively, the processor 610 may include electronic circuitry for performing the functionality described herein, including the functionality of instructions 622-626. With respect of the executable instructions represented as boxes in FIG. 6, it should be understood that part or all of the executable instructions and/or electronic circuits included within one box may, in alternative implementations, be included in a different box shown in the figures or in a different box not shown.

The machine-readable medium 620 may be any medium suitable for storing executable instructions, such as a random-access memory (RAM), electrically erasable programmable read-only memory (EEPROM), flash memory, hard disk drives, optical disks, and the like. In some example implementations, the machine-readable medium 620 may be a tangible, non-transitory medium, where the term “non-transitory” does not encompass transitory propagating signals. The machine-readable medium 620 may be disposed within the processor-based system 600, as shown in FIG. 6, in which case the executable instructions may be deemed “installed” on the system 600. Alternatively, the machine-readable medium 620 may be a portable (e.g., external) storage medium, for example, that allows system 600 to remotely execute the instructions or download the instructions from the storage medium. In this case, the executable instructions may be part of an “installation package”. As described further herein below, the machine-readable medium may be encoded with a set of executable instructions 622-626.

Instructions 622, when executed by the processor 610, may cause the processor 610 to receive an arrangement of a 3D object in a virtual build volume to be generated by a 3D printer.

Instructions 624, when executed by the processor 610, may cause the processor 610 to determine data indicative of the expected warpage of a portion of the 3D object.

Instructions 626, when executed by the processor 610, may cause the processor 610 to modify the virtual build volume to add at least one anchor structure connected to the portion of the 3D object if the expected warpage is above a predeterminable threshold, wherein the anchor structure comprises a body located at an offset from the 3D object and at least a pin to connect the body with the portion of the 3D object.

The above examples may be implemented by hardware, or software in combination with hardware. For example, the various methods, processes and functional modules described herein may be implemented by a physical processor (the term processor is to be implemented broadly to include CPU, SoC, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, method and functional modules are implemented as machine-readable instructions executable by at least one processor, hardware logic circuitry of the at least one processor, or a combination thereof.

The drawings in the examples of the present disclosure are some examples. It should be noted that some units and functions of the procedure may be combined into one unit or further divided into multiple sub-units. What has been described and illustrated herein is an example of the disclosure along with some of its variations. The terms, descriptions and figures used herein are set forth by way of illustration. Many variations are possible within the scope of the disclosure, which is intended to be defined by the following claims and their equivalents.

There have been described example implementations with the following sets of features:

Feature set 1: A computing system comprising a controller to:
receive an arrangement of a 3D object in a virtual build volume to be generated by a 3D printer;
determine an indication of the expected warpage of a portion of the 3D object; and
modify the virtual build volume to add at least one anchor structure connected to the portion of the 3D object if the expected warpage is above a predeterminable threshold.

Feature set 2: A computing system with feature set 1, wherein the anchor structure comprises a body located at an offset from the 3D object; and at least one pin to connect the body with the portion of the 3D object.

Feature set 3: A computing system with preceding feature set 2, wherein the body has a deformation stable shape.

Feature set 4: A computing system with any preceding feature set 2 to 3, wherein the body comprises a cubical, a spherical, a rectangular section prism, and/or a cylindrical shape.

Feature set 5: A computing system with any preceding feature set 2 to 4, wherein the anchor structure further comprises a reinforcement portion between the body and the at least one pin.

Feature set 6: A computing system with any preceding feature set 1 to 5, wherein the controller is further to: receive the arrangement of the 3D object to be printed; determine the data from the portion of a 3D object based on the geometry of the portion of the 3D object; and arrange the 3D object in the virtual build volume based on the determined data.

Feature set 7: A computing system with any preceding feature set 1 to 6, wherein the controller is further to: compare the received arrangement of the 3D object in the virtual build volume with a virtual build volume model indicative of an expected warpage of a portion of the 3D object based on its arranged location within the virtual build volume; detect if the expected warpage of the portion of a 3D object exceeds the predeterminable threshold; and re-arrange the 3D object within the virtual build volume based on the detection.

Feature set 8: A computing system with any preceding feature set 1 to 7, wherein the virtual build volume model is a thermal cooling model or a shrinkage model.

Feature set 9: A computing system with any preceding feature set 1 to 8, wherein the controller is further to re-arrange the 3D object by placing the 3D object at a location closer to the central position within the virtual build volume than in the received arrangement.

Feature set 10: A method comprising:
receiving a 3D object to be printed by a 3D printer;
arranging the 3D object in a virtual build volume;
determining data indicative of the expected warpage of a portion of the 3D object; and
modifying the virtual build volume to add at least one anchor structure connected to the portion of the 3D object if the expected warpage is above a predeterminable threshold.

Feature set 11: A method with preceding feature set 10, further comprising slicing the resulting virtual build volume including the plurality of 3D objects and the at least one anchor structure.

Feature set 12: A method with any preceding feature set 10 to 11, wherein the anchor structure comprises a body located at an offset from the 3D object; and at least one pin to connect the body with the portion of the 3D object.

Feature set 13: A method with any preceding feature set 10 to 12, further comprising: determining the data from the portion of a 3D object based on the geometry of the portion of the 3D object; and arranging the 3D object in the virtual build volume based on the determined data.

Feature set 14: A method with any preceding feature set 10 to 13, further comprising: comparing the arrangement of the 3D object in the virtual build volume with a virtual build volume model indicative of an expected warpage of a portion of the 3D object based on its arranged location within the virtual build volume; detecting if the expected warpage of the portion of a 3D object exceeds the predeterminable threshold; and re-arranging the 3D object within the virtual build volume based on the detection.

Feature set 15: A non-transitory machine-readable medium storing instructions executable by a processor, the non-transitory machine-readable medium comprising:
instructions to receive an arrangement of a 3D object in a virtual build volume to be generated by a 3D printer;
instructions to determine data indicative of the expected warpage of a portion of the 3D object; and
instructions to modify the virtual build volume to add at least one anchor structure connected to the portion of the 3D object if the expected warpage is above a predeterminable threshold, wherein the anchor structure comprises a body located at an offset from the 3D object and at least a pin to connect the body with the portion of the 3D object.

What it is claimed is:

1. A computing system comprising:
a controller to:
receive an arrangement of a 3D object in a virtual build volume to be generated by a 3D printer;
determine an indication of the expected warpage of a portion of the 3D object; and
modify the virtual build volume to add at least one anchor structure connected to the portion of the 3D object if the expected warpage is above a predeterminable threshold.

2. The computing system of claim 1, wherein the anchor structure comprises:
a body located at an offset from the 3D object; and
at least one pin to connect the body with the portion of the 3D object.

3. The computing system of claim 2, wherein the body has a deformation stable shape.

4. The computing system of claim 3, wherein the body comprises a cubical, a spherical, a rectangular section prism, and/or a cylindrical shape.

5. The computing system of claim 2, wherein the anchor structure further comprises a reinforcement portion between the body and the at least one pin.

6. The computing system of claim 1, wherein the controller is further to:
receive the arrangement of the 3D object to be printed;
determine the data from the portion of a 3D object based on the geometry of the portion of the 3D object; and
arrange the 3D object in the virtual build volume based on the determined data.

7. The computing device of claim 1, wherein the controller is further to:
compare the received arrangement of the 3D object in the virtual build volume with a virtual build volume model indicative of an expected warpage of a portion of the 3D object based on its arranged location within the virtual build volume;
detect if the expected warpage of the portion of a 3D object exceeds the predeterminable threshold; and
re-arrange the 3D object within the virtual build volume based on the detection.

8. The computing system of claim 7, wherein the virtual build volume model is a thermal cooling model or a shrinkage model.

9. The computing system of claim 7, wherein the controller is further to re-arrange the 3D object by placing the 3D object at a location closer to the central position within the virtual build volume than in the received arrangement.

10. A method comprising:
receiving a 3D object to be printed by a 3D printer;
arranging the 3D object in a virtual build volume;
determining data indicative of the expected warpage of a portion of the 3D object; and
modifying the virtual build volume to add at least one anchor structure connected to the portion of the 3D object if the expected warpage is above a predeterminable threshold.

11. The method of claim 10 further comprising slicing the resulting virtual build volume including the plurality of 3D objects and the at least one anchor structure.

12. The method of claim 10, wherein the anchor structure comprises:
a body located at an offset from the 3D object; and
at least one pin to connect the body with the portion of the 3D object.

13. The method of claim 10, further comprising
determining the data from the portion of a 3D object based on the geometry of the portion of the 3D object; and
arranging the 3D object in the virtual build volume based on the determined data.

14. The method of claim 10, further comprising:
comparing the arrangement of the 3D object in the virtual build volume with a virtual build volume model indicative of an expected warpage of a portion of the 3D object based on its arranged location within the virtual build volume;
detecting if the expected warpage of the portion of a 3D object exceeds the predeterminable threshold; and
re-arranging the 3D object within the virtual build volume based on the detection.

15. A non-transitory machine-readable medium storing instructions executable by a processor, the non-transitory machine-readable medium comprising:
instructions to receive an arrangement of a 3D object in a virtual build volume to be generated by a 3D printer;
instructions to determine data indicative of the expected warpage of a portion of the 3D object; and
instructions to modify the virtual build volume to add at least one anchor structure connected to the portion of the 3D object if the expected warpage is above a predeterminable threshold, wherein the anchor structure comprises a body located at an offset from the 3D object and at least a pin to connect the body with the portion of the 3D object.
